(19) United States
(12) Patent Application Publication
(10) Pub. No.: US 2005/0090127 A1
(43) Pub. Date: Apr. 28, 2005

(54) Device for connecting electric components

(76) Inventors: Peter Ivan Astere Van Den Heede, Deinze-Vinkt (BE); Fredien Jan Elisabeth Waterschoot, Sint-Niklaas (BE)

Correspondence Address: BACON & THOMAS, PLLC, 625 SLATERS LANE, FOURTH FLOOR, ALEXANDRIA, VA, 22314, US

(21) Appl. No.: 10/968,896

(22) Filed: Oct. 21, 2004

(30) Foreign Application Priority Data
Oct. 23, 2003 (BE) 2003/0562

(51) Int. Cl. H01R 12/00

(52) U.S. Cl. 439/74

(57) ABSTRACT

Device for connecting electric components comprising a contact support (1) which can be connected to a connecting element (2) on a first side (10) and which can be connected to at least one application element (3, 4, 5) on a second side (40) situated opposite to the first side (10).

### BACKGROUND OF THE INVENTION

1. Field of the Invention

The invention concerns a device for connecting electric components.

2. Discussion of the Related Art

It is known to mutually connect electric components by means of a wall print which is provided with terminal clamps for a cable on a first side and which can be provided with bush touch buttons on the other side which can be fixed onto the wall print. Such a wall print is disadvantageous in that connecting a cable to the terminal clamps of the wall print is difficult to realize. Besides, the position of the wall print at the time the cable is being connected to the terminal clamps of the wall print is already determined.

### SUMMARY OF THE INVENTION

The invention aims a device for connecting electric components which does not have the above-mentioned disadvantages and which makes it possible to realize a connection between electric components in a simple manner.

To this aim, the device according to the invention comprises a contact support which can be mechanically connected to a connecting element on one side, and which can be mechanically connected to at least one application element on a second side opposite the first side, whereby the contact support on the first side comprises first contact elements which can make an electric contact with contact elements of the connecting element, whereby the contact support on the second side comprises second contact elements which can make an electric contact with the contact elements of at least the single application element, and whereby the contact support comprises electric connections which electrically connect the above-mentioned first contact elements to the above-mentioned second contact elements.

The device according to the invention comprising an above-mentioned contact support is advantageous in that an electric connection between contact elements of the connecting element and contact elements of at least the single application element can always be realized via the contact support, and in that, via the contact support, a mechanical connection can also be formed between the connecting element and at least the single application element. The device according to the invention is also advantageous in that, by making use of a contact support according to the invention, an arbitrary number of application elements can be provided on a connecting element. The invention is also advantageous in that the number of application elements can be selected independently of the connecting element. This is particularly advantageous in that the installer only has to mount a connecting element, and in that the number of application elements and the contact support only have to be selected afterwards. This is also advantageous in that the number of application elements and the contact support can still be altered as well afterwards without having to change the connecting element. This also means that an installer can finish the complete installation of the connecting elements without having to know all the details regarding the application elements. As several application elements can be connected per connecting element, the end user can wait until the last moment to pass the required application elements or control functions to the installer, and/or the end user can change the application elements or control functions until the last moment or even thereafter. Making an electric contact by means of contact elements is also advantageous in that an electric contact can be realized once or several times in a simple manner and without damaging the contact elements.

According to a preferred embodiment, the contact support can be connected to several application elements on the second side. The contact support hereby comprises several sets of second contact elements which can each make contact with contact elements of an application element, and electric connections which can mutually connect the above-mentioned sets of contact elements in an electrical manner. This makes it possible to connect several application elements both mechanically and electrically to a single connecting element via a contact support.

According to a preferred embodiment, the contact support can be provided so as to be attached to the connecting element in several positions on the first side. The contact support, according to one possibility, hereby comprises several sets of first contact elements on the first side which can each make contact with contact elements of the connecting element, and electric connections which mutually connect the above-mentioned sets of contact elements in an electric manner. This makes it possible to arrange the contact support in a number of specific positions in relation to the connecting element. According to yet another possibility, the contact support comprises at least one set of longitudinal first contact elements which can make contact with contact elements of the connecting element in several mutual positions of the contact support and the connecting element. This makes it possible to arrange the contact support in a large number of positions in relation to the connecting element. As a result, the position of the contact support is no longer univocally determined by the erection position of the connecting element, so that a precise positioning of the connecting element is less stringent as well. This makes it possible, for example, to arrange the contact support in different positions in relation to the connecting element, in the height as well as in the width. This is also advantageous when the number of application elements is selected only after the connecting element has been erected.

The device according to the invention whereby the contact support can be mechanically connected to the connecting element in a specific position and whereby at least the single application element can be mechanically fixed to the contact support in a specific position, also allows for these positions to be selected such that the electric connections between contact elements of the connecting element and contact elements of at least the single application element can always be correctly obtained. As a result, wrong electric connections are excluded as well.

According to one embodiment, the contact support comprises positioning elements which can work in conjunction with positioning elements of an application element. This makes it possible to mutually position the contact support and an application element when they are mechanically attached to each other. This is advantageous in that they can always be positioned and attached in a specific mutual position. As a result, wrong electric connections are excluded as well.

According to one embodiment, the contact support comprises positioning elements which can work in conjunction with positioning elements of a connecting element. This makes it possible to mutually position the contact support and the connecting element when they are mechanically fixed to each other. This is advantageous in that they can always be positioned and fixed in a specific mutual position. As a result, wrong electric connections are excluded as well.

According to one embodiment, the contact support comprises electric connections which consist of copper paths. Such copper paths can be provided in a simple and known manner to the contact support. This makes it possible to mutually connect contact elements in a simple manner.

According to one embodiment, the contact support comprises the above-mentioned first contact elements and/or the above-mentioned second contact elements which can form an electric surface contact with other contact elements, in particular an almost flat electric surface contact. Such contact elements of the contact support may consist of flat contact plates which are preferably erected parallel to one side of the contact support. Providing flat contact plates as contact elements on the contact support is advantageous in order to prevent damage to such contact elements and in order to obtain a robust contact support.

According to one embodiment, the device according to the invention also comprises at least one connecting element, whereby at least the single connecting element comprises contact elements which can make an electric contact with contact elements of the contact support. Such contact elements of the connecting element can co-operate with any connecting bush whatsoever, irrespective of the contact support of the application elements.

According to one embodiment, the device according to the invention also comprises a connecting element which has an exit which can be connected to a connecting bush. According to one possibility, said exit comprises terminal clamps for connecting a cable which is part of a connecting bush. According to another possibility, the exit comprises a transmitter and/or a receiver which is part of a network and which can work in conjunction with another transmitter and/or another receiver of the network.

According to one embodiment, the connecting element comprises contact elements which can make an electric contact with contact elements of the contact support and electric connections which directly connect the above-mentioned contact elements of the connecting element to the exit of the connecting element. According to a variant of the embodiment, the connecting element comprises electronic parts which are provided between the contact elements of the connecting element and the exit of the connecting element, and which indirectly connect the above-mentioned contact elements of the connecting element to the exit of the connecting element. Such electronic parts make it possible for example to transform electric signals between an application element and the above-mentioned exit, in particular to amplify, change or transform them in any other way whatsoever.

According to one embodiment, the device according to the invention also comprises at least one application element, whereby at least the single application element comprises contact elements which can make an electric contact with contact elements of the contact support. The set-up of such contact elements can be selected independently of the set-up of the contact elements of the connecting element.

According to one embodiment, the contact elements of the connecting element and/or the contact elements of at least the single application element comprise springy or spring-mounted contact parts. Such contact elements preferably comprise an arched contact part. Such a contact element can be made as an arched leaf spring or as an arched contact plate which is supported by a spring. Such spring-mounted contact parts, and in particular such spring-mounted arched contact parts guarantee a good electric connection, even if the contact elements to be electrically connected are not positioned or aligned precisely in relation to the contact elements of the contact support. Such contact elements are also advantageous in that, during the formation of each electric connection to other contact elements, they make a relative movement in relation to those other contact elements, and in this manner are cleaned so to say during each electric connection.

### BRIEF DESCRIPTION OF THE DRAWINGS

The characteristics and further advantages of the invention will be further explained in the following detailed description by means of the non-limitative examples of embodiments, represented in the accompanying drawings. In this description is being referred to the following drawings, in which:

FIG. 1 schematically represents a view in perspective according to a front side of a device according to the invention, including among others a connecting element and several application elements in a non-mounted situation;

FIG. 2 represents the back of an application element of FIG. 1 in perspective;

FIG. 3 represents the front side of the contact support of FIG. 1 in perspective;

FIG. 4 represents the back of the contact support of FIG. 1 in perspective;

FIGS. 5 to 7 are side-views of the assembled whole with the contact support placed in different positions in relation to the connecting element;

FIG. 8 represents a variant of a part of FIG. 1;

FIG. 9 represents a variant of FIG. 8.

### DESCRIPTION OF THE PREFERRED EMBODIMENTS

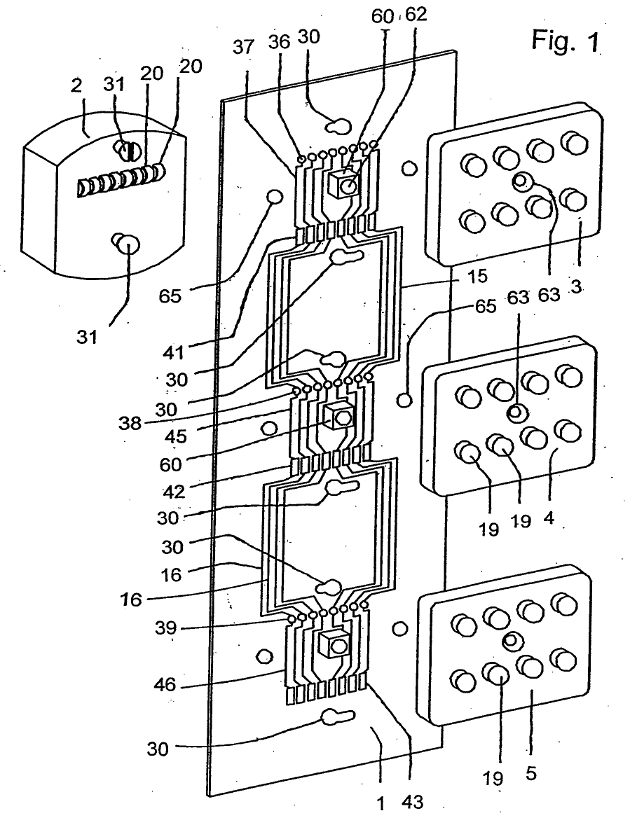

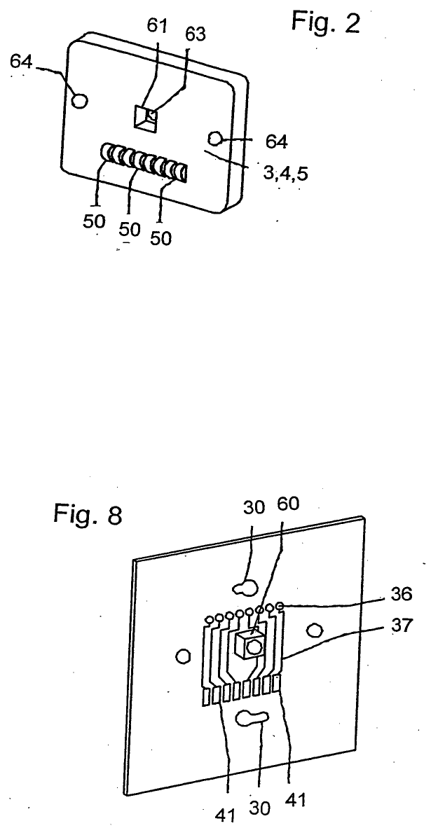

FIGS. 1 to 5 represent a device according to the invention comprising a contact support 1, a connecting element 2 and several application elements 3, 4 and 5. The contact support 1 comprises, on a first side 10, several sets of first contact elements 11, 12 and 13 respectively which can each form an electric contact with contact elements 20 of the connecting element 2 as desired, and electric connections 15, 16, 36, 37, 38, 39 and 45 which mutually connect the contact elements 11, 12 and 13 of the above-mentioned sets of contact elements in an electric manner.

The contact support 1 can be mechanically connected, on the first side 10, with a connecting element 2, and it is equipped to be attached to the connecting element 2 on the first side 10 in several positions. The contact support 1 hereby comprises several positioning elements 30 which can respectively work in conjunction with accompanying positioning elements 31 of a connecting element 2. The positioning elements 30 comprise for example profiled openings which extend through the contact support 1. In the given example, the positioning elements 31 consist of screws which can be screwed in the connecting element 2. These screws can extend through the positioning elements 30 of the contact support 1 and they make it possible to mechanically fix the contact support 1 to the connecting element 2 in a specific position.

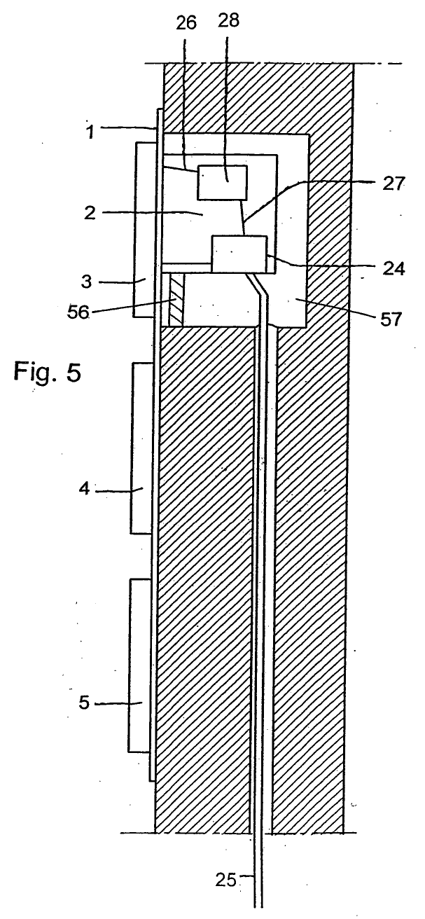

Further, the connecting element 2 comprises a schematically indicated exit 24 which can be connected to a connecting bush 25. A cable can hereby be connected from the connecting bush 25 via terminal clamps to the exit 24 of the connecting element 2. The cable can hereby be connected by an installer before the contact support 1 is to be provided. While providing the contact support 1, the installer no longer has to change anything to the connection of the cable with the connecting element 2. Besides, the installer can mount a type of contact support as desired without having to change the connection of the cable. As is schematically indicated in FIG. 5, the connecting element 2 comprises electric connections which each connect contact elements 20 of the connecting element 2 to the exit 24 of the connecting element 2. Such a connection may comprise, as represented in FIG. 5, electric conductors 26, 27 and for example electronic parts 28 for transforming signals. According to a variant, the guides 26, 27 can also directly connect the contact elements 20 to the exit 24, and in this manner form the connections.

The contact support 1 can be further mechanically connected, on the second side 40 opposite to the first side 10, to at least one application element 3, 4 or 5. The contact support 1 hereby comprises, on the second side 40, several sets of second contact elements 41, 42 and 43 respectively, which can each make contact with accompanying contact elements 50 of an application element 3, 4 or 5, and electric connections 15, 16, 45 and 46 which mutually connect the above-mentioned sets of contact elements 41, 42 and 43 in an electric manner. The contact support 1 comprises positioning elements 60 which can work in conjunction with positioning elements 61 of an application element 3, 4 or 5. The positioning elements 60 comprise for example a positioning block, whereas the positioning elements 61 have for example a square opening provided in the application element 3, 4 or 5. Further, the contact support 1 comprises, at the height of each positioning block, for example threaded internal bores 62 which make it possible to mechanically connect an application element 3, 4 or 5 to the contact support 1 via non-represented screws. The non-represented screws hereby extend through a bore 63 of the application element 3, 4 or 5 provided in the extension of the above-mentioned square opening. As a variant or in combination, every application element 3, 4 or 5 may also comprise tapered positioning elements 64 which can work in conjunction with positioning elements 65 of the contact support 1 embodied as bores.

The use of positioning elements 30, 31, 60, 61, 64 and 65 is also advantageous in that electrically connecting contact elements in a wrong manner is excluded, since the positioning elements can mechanically determine the mutual position of the contact elements to be connected in a univocal manner. This is also advantageous when replacing application elements or contact supports.

The connecting element 2 can for example also work in conjunction with a schematically represented fastening element 56 which makes it possible to fasten said connecting element 2 somewhere. This allows, for example, to erect the connecting element 2 fixed in relation to a cavity 57 in a wall or fixed in relation to a rail or any other element whatsoever in a known manner. For example, the connecting element 2 can be held, clamped or fixed to this end in a non-represented housing of the fastening element 56 in a known manner.

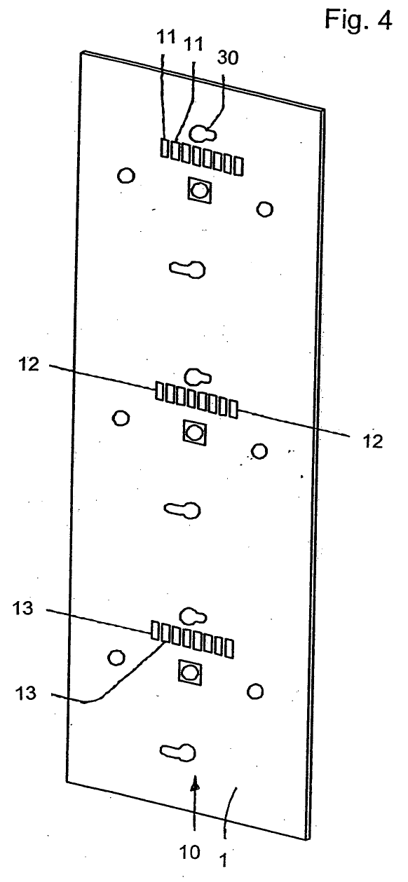

The contact support 1 hereby comprises, as is schematically represented in FIG. 4, electric connections 15, 16, 36, 37, 38, 39, 45 and 46 which make it possible to electrically connect the above-mentioned first contact elements 11, 12 and 13 to the above-mentioned second contact elements 41, 42 and 43. In the given example are each time provided eight of these electric connections. The electric connections 15, 16, 37, 45 and 46 are formed of copper conductors or copper paths erected next to each other. The connections 36, 38 and 39 may extend from the first side 10 to the second side 40 through the contact support 1 and they can electrically connect the contact elements 11, 12 and 13 respectively to the connections 37, the connections 15 and 45 and the connections 16 and 46. The electric connections 15 and 16 are hereby also connected to the electric connections 45 and 46. As mentioned above, the respective contact elements 11, 12 and 13 are also mutually connected to electric connections, and the respective contact elements 41, 42 and 43 are also mutually connected to electric connections, and thus the contact elements 11, 12 and 13 are also connected to the contact elements 41, 42 and 43 via the above-mentioned electric connections.

As can be seen, the contact support 1 comprises contact elements 11, 12 and 13 and/or contact elements 41, 42 and 43 which can form an almost flat electric surface contact with contact elements of a connecting element 2 or with contact elements 50 of an application element 3, 4, 5. The contact elements 11, 12 and 13 and the contact elements 41, 42 and 43 of the contact support 1 hereby consist for example of flat contact plates. In the given example, these contact plates are erected parallel to one side 10 and/or to one side 40 of the contact support 1. The above-mentioned contact elements of the contact support 1 can respectively work in conjunction with contact elements 20 of the connecting element 2 or with contact elements 50 of one of the application elements 3 to 5. The contact elements 20 or 50 may comprise springy or spring-mounted contact parts in the known manner. Such contact elements preferably comprise an arched contact part which is part of an arched leaf spring or an arched contact plate which is supported by a spring. The use of contact elements forming a flat surface contact is advantageous in that no precise mutual positioning of such contact elements is required, which makes it possible to position such contact elements with relatively large mutual tolerances. This is also advantageous in that no precise mutual positioning of the connecting element and the contact support and/or of the contact support and the application element is required either. This implies that a good electric connection can be obtained, even if the above-mentioned contact elements are not positioned in a precise mutual position or with a certain mutual play. Such contact elements also keep guaranteeing a good electric contact even if the contact elements, after the electric connection has been formed, are moved somewhat in relation to each other, for example due to the influence of expansions caused by differences in temperature.

According to a variant of the embodiment, at least a part of the contact elements of the contact support 1 may also consist of spring-mounted contact elements. The contact elements 50 of the application element may hereby consist for example of flat contact plates, which are preferably erected parallel to each other and parallel to the contact support 1 when mounted and which can work in conjunction with spring-mounted contact elements of the contact support 1. According to another variant, all contact elements to be electrically connected may consist of spring-mounted contact elements.

According to one embodiment, the contact support 1 is mainly formed of what is called an electric print, in particular a synthetic support upon which has been provided a thin layer of electrically conductive material with a suitable shape, for example copper paths. Such copper paths may for example form the contact elements of the contact support 1 and the above-mentioned connections 15, 16, 37, 45 and 46. Through the synthetic support hereby also extend the above-mentioned connections 36, 38 and 39, for example copper conductors which mutually connect the above-mentioned thin layers of electrically conductive material, provided on either side of the contact support 1. The above-mentioned copper conductors can also be formed of copper paths. Providing the electric connections 15, 16, 37, 45 and 46 on one and the same side 40 of the contact support 1 is advantageous among others in that the above-mentioned print can be made in a simple manner.

According to one embodiment, the application element 3, 4 or 5 consists of an operating module, in particular an operating module with a number of what are called bush touch buttons 19 which can generate an electric signal which can be transmitted for example via the contact support 1 and the connecting element 2 to a connecting bush 25. Such a connecting bush 25 can also be connected to a control module such as an electrically controlled switch module, a relay or any other electric or electrically controlled unit. The application element can also comprise lamps that are controlled via the connecting bush 25. Providing an application element with at least one bush touch button which can generate its own signal or what are called telegrams with a unique code is advantageous in that the position of the application element on the contact support 1 is not important and in that each application element can transmit suitable signals, via the contact support, to the connecting element 2 which can be transmitted to a connecting bush 25 via the connecting element 2.

From FIGS. 5, 6 and 7 it is clear that the contact support 1 can be erected in different positions in relation to the connecting element 2. The latter is possible while the connecting element 2 stays erected in one and the same position, and nothing is eventually changed at the height of the connecting element 2. In each of the positions of FIGS. 5 to 7, the contact elements 20 of the connecting element 2 make contact with another set of contact elements of the contact support 1, in particular with the upper set of contact elements 11, the middle set of contact elements 12 and the bottom set of contact elements 13 of the contact support 1 respectively. This is advantageous in that the installer can freely install the contact support 1 in one of the above-mentioned positions as desired.

According to the embodiment of FIG. 7, the exit 24 is connected to a transmitter and/or a receiver 55 which is part of a network and which can work in conjunction with another transmitter and/or receiver of the network. Such a transmitter and/or receiver can for example work with infrared light beams or on the basis of radio-frequency waves.

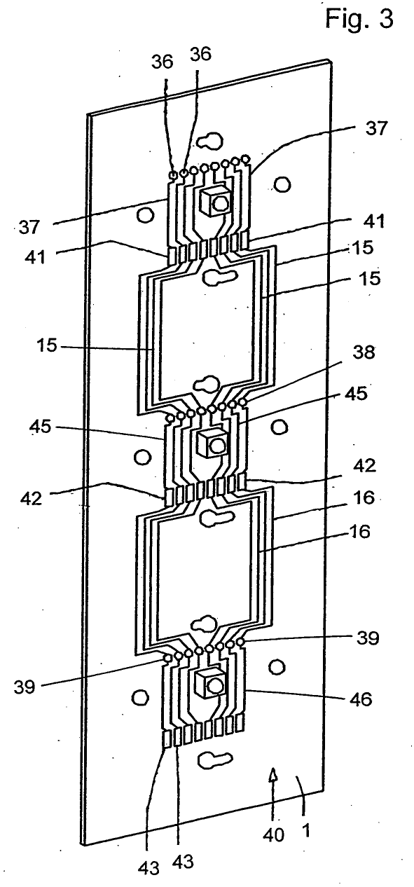

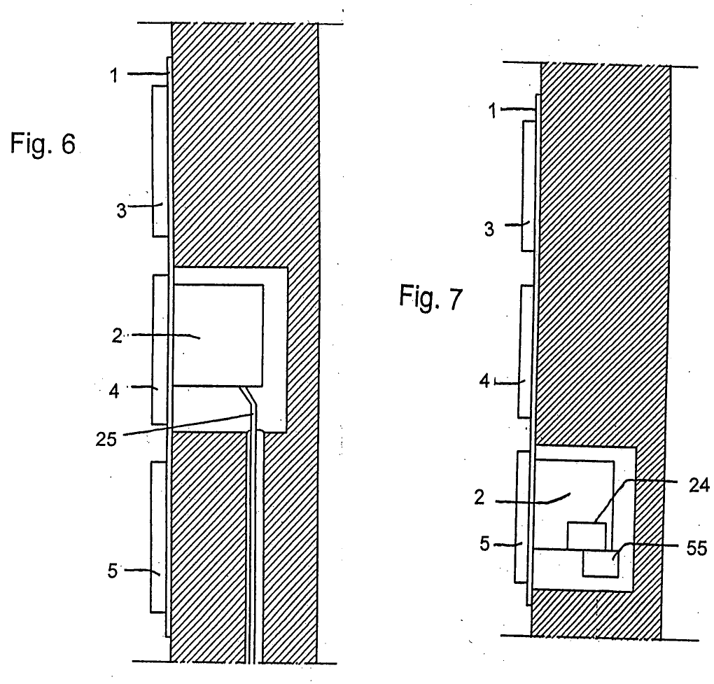

FIG. 8 represents a variant whereby the contact support 1 on the second side 40 comprises at least one set of contact elements 41 which can make contact, just as the contact elements 41, 42 or 43 from FIG. 3, with contact elements 50 of an application element. Hereby are also provided connections 36 and 37 which connect the contact elements 41 with non-represented contact elements provided on the other side of the contact support 1 and which can work in conjunction with contact elements 20 of the connecting element 2 in an analogous manner as the contact elements 11, 12 or 13 from FIG. 4.

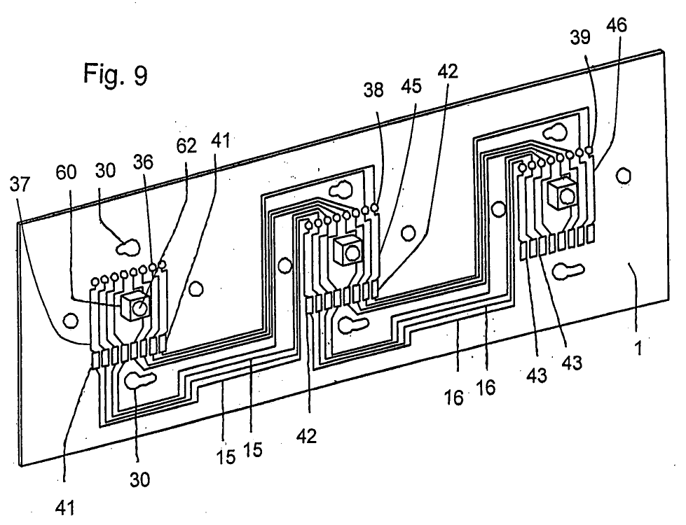

Although, in the given embodiments, each time three application elements 3, 4, 5 are represented, it is also possible to provide another number of application elements on a specific contact support 1. Naturally, such application elements must not necessarily be erected vertically in one line, but they can for example also be divided over one side of the contact support, for example at the height of the angles of a rectangle or a square. It is clear that the contact support can hereby have suitable dimensions. As an example, FIG. 9 represents a contact support 1 for three application elements which are erected horizontally next to each other. The contact elements 41, 42 and 43 are hereby mutually connected by the connections 15, 16, 36, 37, 38, 39, 45 and 46 with non-represented contact elements situated opposite to the connections 36, 38 and 39 respectively on the other side of the contact support 1 and they are made analogous to the contact elements 11, 12 and 13 of FIG. 1.

Although, in the given embodiments, sets of each time eight contact elements are electrically connected to each other, it is clear that, according to the invention, it is also possible to mutually connect sets of contact elements to another number of contact elements in an electric manner. It is clear that not always all contact elements have to be used. For example, with a certain application element having only four contact elements, of the eight contact elements present of the contact support, only four accompanying contact elements are actually used.

It is also clear that, on a certain connecting element 2, a contact support for at least one application element can be provided. It is also possible to replace a contact support provided on a connecting element 2 by another contact support for more or less application elements. It is also clear that, on a contact support for a number of application elements, also less of such application elements can be provided and that, at the height of the contact elements which do not make contact with an application element, for example a cover plate can be provided to cover the contact elements of the contact support.

According to a non-represented variant, it is also possible to make a contact support 1 work in conjunction with several connecting elements 2, whereby for example the contact elements 20 of each connecting element 2 can make contact with an accompanying set of contact elements 11, 12 and 13 of the contact support 1.

In order to obtain a robust contact support, it is advantageous to not provide any electronic components nor any moving contact elements in the contact support. However, it is not excluded for the contact support to contain electronic components and/or moving contact elements.

It is clear that the contact elements of the contact support must not necessarily be erected in a straight line, but that they can also be erected for example rather in a circular or arched shape. This can for example be advantageous in order to enable the contact support to rotate in relation to the connecting element, and the connecting element will have to be positioned less precisely.

In case a contact support comprises an electric print, such a contact support may also be called a supporting print. In case such a contact support is erected against a wall, it may also be called a wall print.

In order to exclude wrong electric connections of electric contact elements, the contact elements of the contact support, the connecting element and/or the application element are preferably not provided symmetrically, nor mirror-symmetrically. Naturally, it is not excluded for the above-mentioned contact elements to be erected symmetrically or mirror-symmetrically.

It is clear that on each side 10 or 40 of a contact support according to the invention must not necessarily be provided an equal number of sets of contact elements that are connected by accompanying electric connections, but that also a different number of sets of contact elements can be provided per side 10 or 40. According to a non-represented example, two sets of first contact elements 11 and 12 can be provided for example on a first side 10, whereas on the other side 40, for example three sets of second contact elements 41, 42 and 43 are provided.

According to a non-represented variant, the connecting element 2 on the first side 10 of the contact support 1 can be mechanically connected to the contact support by means of a fastening element onto which the connecting element as well as the contact support can be fixed. This fastening element can for example be provided fixed in relation to a cavity 57 in the wall, analogous to the fastening element 56 which is schematically represented in FIG. 5, in order to erect the connecting element 2 in a fitting manner. To this end, this fastening element can for example be provided with known clamps, screws and supporting surfaces to erect this fastening element in the known manner in an above-mentioned cavity 57 such that it fits, and to fix it tightly. The screws 31 can hereby be used, for example, to fix the connecting element 2 to this fastening element, and this fastening element can be provided with screws which can work in conjunction with the openings 32 or with other openings of the contact support 1 in order to fix the contact support 1 to this fastening element.

The device according to the invention can be used in several applications. Such a device is fit to be used among others in electric installations for domestic appliances or what are called domotica systems. The device according to the invention is preferably used in the low-voltage current part of a switch system for illuminating a house. Naturally, the device according to the invention can also be used for electrically guiding communication signals, for example analogous or digital low-voltage communication signals, as well as for signals for electric energy transmission, for example power-current signals for feeding an electric unit. It is clear that the invention is in the first place meant rather for electrically conducting low-voltage signals.

The device according to the invention offers as further advantages that it can be made in a simple and economical manner. Naturally, the device according to the invention is not restricted to the embodiments described in the examples, but it may also comprise variants and combinations of these embodiments.

1. A device for connecting electric components, wherein the device comprises a contact support which can be mechanically connected to a connecting element on a first side and which can be mechanically connected to at least one application element on a second side situated opposite to the first side, whereby the contact support on the first side comprises first contact elements which can form an electric contact with contact elements of the connecting element, whereby the contact support on the second side comprises second contact elements which can make an electric contact with contact elements of at least one application element and whereby the contact support comprises electric connections which electrically connect the above-mentioned first contact elements to the above-mentioned second contact elements.

2. The device according to claim 1, wherein the contact support on the second side comprises several sets of second contact elements which can each make contact with contact elements of an application element, and electric connections which mutually connect the above-mentioned sets of second contact elements in an electric manner.

3. The device according to claim 1, wherein the contact support is provided to be fixed to the connecting element in several positions on the first side.

4. The device according to claim 1, wherein the contact support on the first side comprises several sets of first contact elements which can each make contact with contact elements of the connecting element, and electric connections which mutually connect the above-mentioned sets of contact elements in an electric manner.

5. The device according to claim 1, wherein the contact support comprises positioning elements which can work in conjunction with positioning elements of an application element.

6. The device according to claim 1, wherein the contact support comprises positioning elements which can work in conjunction with positioning elements of a connecting element.

7. The device according to claim 1, wherein the contact support comprises electric connections which consist of copper paths.

8. The device according to claim 7, wherein the above-mentioned electric connections are provided on one and the same side of the contact support.

9. The device according to claim 1, wherein the contact support comprises first and/or second contact elements which can form an electric surface contact with other contact elements, more particularly an almost flat electric surface contact.

10. The device according to claim 9, wherein the contact elements of the contact support consist of flat contact plates which are erected parallel to one side of the contact support.

11. The device according to claim 1, wherein the device comprises at least one connecting element, whereby at least the single connecting element comprises contact elements which can make an electric contact with contact elements of the contact support.

12. The device according to claim 11, wherein the connecting element comprises an exit which can be connected to a connecting bush.

13. The device according to claim 1, wherein the device comprises at least one application element, whereby at least the single application element comprises contact elements which can make an electric contact with contact elements of the contact support.

14. The device according to claim 1, wherein the contact elements of the connecting element and/or the contact elements of at least the single application element comprise springy or spring-mounted contact parts.
